(19) United States
(12) Patent Application Publication
(10) Pub. No.: US 2012/0083981 A1
(43) Pub. Date: Apr. 5, 2012

(54) VEHICLE RUNNING CONTROL APPARATUS

(75) Inventor: Toshihisa NIHEI, Toyota-shi (JP)

(73) Assignee: TOYOTA JIDOSHA KABUSHIKI KAISHA, Toyota-shi (JP)

(21) Appl. No.: 13/237,656

(22) Filed: Sep. 20, 2011

(30) Foreign Application Priority Data
Sep. 30, 2010 (JP) 2010-220493

(51) Int. Cl. G06F 19/00

(52) U.S. Cl. 701/69

(57) ABSTRACT

A vehicle running control apparatus for executing a turn assist control which controls longitudinal forces of wheels so that longitudinal force of a turning inner wheel is lower than longitudinal force of a turning outer wheel by lowering the longitudinal force of the turning inner wheel. The lowering of the longitudinal force of the turning inner wheel is made more difficult to be started and a lowering amount of the longitudinal force of the turning inner wheel is set smaller when difficulty in driving vehicle by wheel drive forces is high as compared with the case where the difficulty in driving vehicle is low. The difficulty in driving vehicle includes at least one of resistance against vehicle movement by wheel drive forces and difficulty in transmitting driving forces from wheels to road surface.

### BACKGROUND OF THE INVENTION

1. Field of the Invention

The present invention relates to a vehicle running control apparatus and, more particularly, to a vehicle running control apparatus that executes turn assist control which controls longitudinal forces of wheels so that longitudinal force of a turning inner wheel is lower than longitudinal force of a turning outer wheel.

2. Description of Related Art

Conventionally, there have been known turn assist controls which, for example, enhance vehicle turning performance by applying braking force to a turning inner rear wheel. An example of the turn assist controls is disclosed in the under-described Japanese Patent Application Laid-Open (kokai) No. Heisei11(1999)-49020.

In the turn assist controls, a yaw moment acting in a direction of assisting vehicle turning is imparted to the vehicle by reducing longitudinal force of a turning inner wheel by means of, for example, applying braking force to a turning inner rear wheel. Accordingly, when the turn assist control is executed, the driving force of the entire vehicle is inevitably decreased.

In particular, when road surface is soft such as in the case where a vehicle runs at off-road area, the turning inner wheel to which braking force is applied tends to dent into road surface and the driving forces of the wheels other than the turning inner wheel are hard to be transmitted to road surface. Accordingly, the driver may feel dissatisfaction such as difficulty in driving the vehicle for the reason that he or she is unable to drive the vehicle as he or she desires.

### BRIEF SUMMARY OF THE INVENTION

A primary object of the present invention is to provide a vehicle running control apparatus which executes turn assist control and reduces the possibility that a driver feels dissatisfaction such as difficulty in driving the vehicle due to the turn assist control.

The present invention provides a vehicle running control apparatus for executing a turn assist control which controls longitudinal forces of wheels so that longitudinal force of a turning inner wheel is lower than longitudinal force of a turning outer wheel by lowering the longitudinal force of the turning inner wheel, wherein the vehicle running control apparatus sets smaller a lowering amount of the longitudinal force of the turning inner wheel when difficulty in driving vehicle by wheel drive forces is high as compared with the case where the difficulty in driving vehicle is low.

According to this configuration, the lowering amount of the longitudinal force of the turning inner wheel is set smaller when difficulty in driving vehicle by wheel drive forces is high as compared with the case where the difficulty in driving vehicle is low. Accordingly, a braking slip of the turning inner wheel is reduced by the value corresponding to the lowering amount of the longitudinal force of the turning inner wheel and the lowering amount of driving force of the entire vehicle is decreased. Therefore, even in the case where road surface is soft, the tendency of the turning inner wheel to dent into road surface is reduced and the driving force of the entire vehicle is increased, which enable to decrease the possibility that the driver feels dissatisfaction such as difficulty in driving the vehicle for the reason that he or she is unable to drive the vehicle as he or she desires.

The above-mentioned configuration may be such that: the vehicle running control apparatus makes the lowering of the longitudinal force of the turning inner wheel more difficult to be started when the difficulty in driving vehicle is high as compared with the case where the difficulty in driving vehicle is low.

According to this configuration, the lowering of the longitudinal force of the turning inner wheel is made more difficult to be started when the difficulty in driving vehicle is high as compared with the case where the difficulty in driving vehicle is low. Accordingly, in addition to enhancing vehicle turning performance under the situation where the difficulty in driving vehicle is low, it is possible to decrease the possibility that the driver feels dissatisfaction such as difficulty in driving the vehicle for the reason that the longitudinal force of the turning inner wheel is lowered by the turn assist control under the situation where the difficulty in driving vehicle is high.

The above-mentioned configuration may be such that: the vehicle running control apparatus calculates an index of difficulty in driving vehicle by wheel drive forces and, when the index is equal to or larger than a correction decision reference value under the situation where the lowering of the longitudinal force of turning inner wheel is conducted, decreases the lowering amount of the longitudinal force of the turning inner wheel so that the lowering amount decreases as the index increases.

According to this configuration, when the index is equal to or larger than a correction decision reference value under the situation where the lowering of the longitudinal force of turning inner wheel is conducted, the lowering amount of the longitudinal force of the turning inner wheel is decreased so that the lowering amount decreases as the index increases. Accordingly, the lowering amount of the longitudinal force of the turning inner wheel can be decreased in accordance with the index.

The above-mentioned configuration may be such that: the vehicle running control apparatus terminates the lowering of the longitudinal force of the turning inner wheel when the index is equal to or larger than a termination decision reference value which is larger than the correction decision reference value.

According to this configuration, the lowering of the longitudinal force of the turning inner wheel is terminated when the index is equal to or larger than a termination decision reference value which is larger than the correction decision reference value. Accordingly, when the index is very high, the lowering of the longitudinal force of the turning inner wheel by the turning assist control can be terminated, which reliably enables to decrease the possibility that the driver feels dissatisfaction such as difficulty in driving the vehicle.

The above-mentioned configuration may be such that: the vehicle running control apparatus calculates an index of difficulty in driving vehicle by wheel drive forces and, when the index is equal to or larger than a start correction reference value at a time when the lowering of the longitudinal force of the turning inner wheel is started, increases a reference value for starting the lowering of the longitudinal force of the turning inner wheel.

According to this configuration, when the index is equal to or larger than a start correction reference value at a time when the lowering of the longitudinal force of the turning inner wheel is started, a reference value for starting the lowering of the longitudinal force of the turning inner wheel is increased. Accordingly, when the index is very high, the lowering of the longitudinal force of the turning inner wheel is made more difficult to be started, which enables to decrease the possibility that the driver feels dissatisfaction such as difficulty in driving the vehicle for the reason that the longitudinal force of the turning inner wheel is lowered by the turn assist control.

The above-mentioned configuration may be such that: the vehicle running control apparatus inhibits starting of the lowering of the longitudinal force of the turning inner wheel when the index is equal to or larger than a start decision reference value which is larger than the start correction reference value.

According to this configuration, when the index is equal to or larger than a start decision reference value which is larger than the start correction reference value, the lowering of the longitudinal force of the turning inner wheel can be prevented from starting.

The above-mentioned configuration may be such that: the vehicle has a selection switch which is operated by a vehicle occupant based on his or her determination on road surface condition and a drive assist unit which displays optimum driving operations in accordance with the operational position of the selection switch, and the vehicle running control apparatus decides the difficulty in driving vehicle on the basis of the operational position of the selection switch.

According to this configuration, the difficulty in driving vehicle is decided on the basis of the operational position of the selection switch, which enables to decrease the lowering amount of the longitudinal force of the turning inner wheel in accordance with the determination of the vehicle occupant on road surface condition.

The above-mentioned configuration may be such that: the difficulty in driving vehicle includes at least one of resistance against vehicle movement by wheel drive forces and difficulty in transmitting driving forces from wheels to road surface.

According to this configuration, the difficulty in driving vehicle includes at least one of resistance against vehicle movement by wheel drive forces and difficulty in transmitting driving forces from wheels to road surface, which enables to decide effectively the difficulty in driving vehicle by wheel drive forces.

It is to be noted that in the present application, “longitudinal force” of a wheel means braking/driving force which assumes a positive value when it acts in forward running direction of a vehicle. The lowering of the longitudinal force of the turning inner wheel includes not only to decrease in magnitude the longitudinal force acting in forward running direction of a vehicle but also to apply longitudinal force opposite the forward running direction of a vehicle to the wheel which generates longitudinal force acting in the forward running direction of the vehicle.

It is to be noted that in the present application, “turning inner rear wheel” means the turning inner wheel which is on the rear side relative to forward running direction of a vehicle. Accordingly, “rear wheel” of “turning inner rear wheel” is a rear wheel of the vehicle when the vehicle advances but is a front wheel of the vehicle when the vehicle runs in rearward direction.

### BRIEF DESCRIPTION OF THE DRAWINGS

The foregoing and/or further objects, features and advantages of the present invention will become more apparent from the following description of a preferred embodiment with reference to the accompanying drawings, in which like numerals are used to represent like elements and wherein:

FIG. 1 is a schematic diagram of a first embodiment of a vehicle running control apparatus according to the present invention which is applied to a four-wheel drive vehicle;

FIG. 2 is a flowchart showing a routine for conducting turn assist control in the first embodiment;

FIG. 3 is a flowchart showing a sub-routine for determining permission of turn assist control in the first embodiment;

FIG. 4 is a flowchart showing a sub-routine for conducting braking pressure control of turn assist control in the first embodiment;

FIG. 5 is a graph showing a relationship among acceleration opening Acc, vehicle inclination angle cp and standard vehicle acceleration Gdt;

FIG. 6 is a graph showing a relationship between acceleration deviation ΔGdv and index Ddv of difficulty in driving vehicle by wheel drive forces;

FIG. 7 is a graph showing a relationship between index Ddv of difficulty and correction coefficient Kdv;

FIG. 8 is a schematic diagram of a second embodiment of a vehicle running control apparatus according to the present invention which is applied to a four-wheel drive vehicle;

FIG. 9 is a flowchart showing a routine for conducting turn assist control in the second embodiment; and

FIG. 10 is a flowchart showing a sub-routine for conducting braking pressure control of turn assist control in the second embodiment.

### DETAILED DESCRIPTION OF THE INVENTION

Some preferred embodiments of the present invention will be described in detail with reference to the accompanying drawings.

### First Embodiment

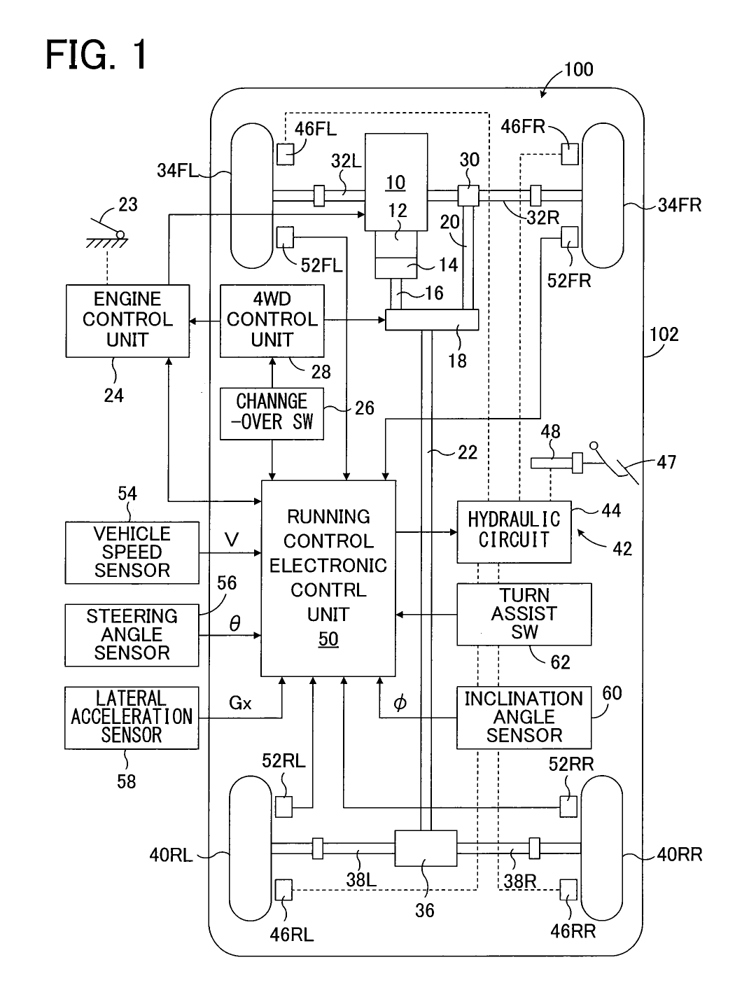

FIG. 1 is a schematic diagram of a first embodiment of a vehicle running control apparatus according to the present invention which is applied to a four-wheel drive vehicle.

Referring to FIG. 1, reference numeral 100 denotes a whole of the vehicle running control apparatus equipped in a vehicle 102. Reference numeral 10 denotes an engine, driving force of which is transmitted to an output shaft 16 via a torque converter 12 and a transmission 14. The driving force is in turn transmitted from the output shaft 16 to a front-wheel propeller shaft 20 and/or a rear-wheel propeller shaft 22 via a transfer 18 which serves as a driving-state switching means. The output of the engine 10 is controlled by an engine control unit 24 in accordance with an amount of depression of an accelerator pedal 23 operated by a vehicle driver, and so on.

The transfer 18 includes an actuator that switches the driving state of the vehicle between four-wheel drive (4WD) and two-wheel drive (2WD) states. The actuator is controlled by a 4WD control unit 28 in response to an operated position of a change-over switch (SW) 26 which is operated by the driver. The change-over switch 26 is selectively operated to either of H4 position, H2 position, N position and L4 position. When the change-over switch 26 is in H4 position, the transfer 18 is set in a 4WD position for transmitting the driving force of the output shaft 16 to both the front-wheel propeller shaft 20 and the rear-wheel propeller shaft 22. When the change-over switch 26 is in H2 position, the transfer 18 is set in a 2WD position for transmitting the driving force of the output shaft 16 only to the rear-wheel propeller shaft 22. When the change-over switch 26 is in N position, the transfer 18 is set in a position for transmitting the driving force of the output shaft 16 to none of the front-wheel propeller shaft 20 and the rear-wheel propeller shaft 22. Furthermore, when the change-over switch 26 is in L4 position, the transfer 18 is set in a 4WD position for transmitting the driving force of the output shaft 16 to both the front-wheel propeller shaft 20 and the rear-wheel propeller shaft 22 as driving force for lower vehicle speed and higher torque situation as compared with the case of H4 position.

As shown in FIG. 1, the 4WD control unit 28 supplies the engine control unit 24 with a signal indicating whether the 4WD control unit 28 has commanded the transfer 18 to be placed in the 2WD or 4WD position, based on a command signal received from the change-over switch 26. In accordance with the position of the transfer 18 commanded by the 4WD control unit 28, the engine control unit 24 controls the output of the engine 10.

The driving force of the front-wheel propeller shaft 20 is transmitted to a front-left axle 32L and a front-right axle 32R via a front-wheel differential 30, so as to rotationally drive a front-left wheel 34FL and a front-right wheel 34FR. Likewise, the driving force of the rear-wheel propeller shaft 22 is transmitted to a rear-left axle 38L and a rear-right axle 38R via a rear-wheel differential 36, so as to rotationally drive a rear-left wheel 40RL and a rear-right wheel 40RR.

Braking forces applied to the front-left, front-right, rear-left and rear-right wheels 34FL, 34FR, 40RL, 40RR, respectively, are controlled by means of braking pressures in wheel cylinders 46FL, 46FR, 46RL, 46RR corresponding to these front and rear wheels 34FL, 34FR, 40, 40 being controlled by a hydraulic circuit 44 of a braking unit 42. Although not shown, the hydraulic circuit 44 includes a reservoir, an oil pump, various valve devices, and so on. The braking pressure in each of the wheel cylinders is normally controlled by a master cylinder 48 that is driven in accordance with an operation of a brake pedal 47 by the vehicle driver. When appropriate, the braking pressure is controlled as needed by a running control electronic control unit 50 as will be described later in detail.

The electronic control unit 50 receives signals indicative of wheel speeds Vfl, Vfr, Vrl, Vrr of the front-left, front-right, rear-left and rear-right wheels from respective wheel speed sensors 52FL, 52FR, 52RL, 52RR. The electronic control unit 50 also receives signals indicative of a vehicle speed V and a steering angle θ from a vehicle speed sensor 54 and a steering angle sensor 56, respectively. The steering angle sensor 56 detects a steering angle, which assumes a positive value when the vehicle makes a left turn.

The electronic control unit 50 receives signals indicative of a longitudinal acceleration Gx of the vehicle and a longitudinal inclination cp of the vehicle from a longitudinal acceleration sensor 58 and an inclination angle sensor 60, respectively. The longitudinal acceleration sensor 58 detects a longitudinal acceleration Gx, which assumes a positive value when it is in the vehicle accelerating direction. The inclination angle sensor 60 detects a longitudinal inclination cp, which assumes a positive value when the vehicle inclines in climbing manner.

The electronic control unit 50 receives, from the change-over switch 26, a signal indicating the position in which the transfer 18 is, and also receives, from a turn assist switch 62 operated by a vehicle occupant, a signal indicating whether the turn assist switch is ON.

The engine control unit 24 receives signals indicative of an accelerator opening Acc from an accelerator opening sensor, not shown in FIG. 1, provided at the accelerator pedal 23. It is to be noted that the engine control unit 24, the 4WD control unit 28, and the electronic control unit 50 may each be actually constituted by a microcomputer including, for example, a CPU, a ROM, a RAM, and I/O devices, and a driving circuit or circuits.

As will be described later in detail, when the turn assist switch 62 is ON, the electronic control unit 50 determines whether or not the application of braking force by turn assist control is to be executed. If the electronic control unit 50 determines that the application of braking force is to be executed, it calculates a target braking slip rate Sbrint of a turning inner rear wheel. Then, the electronic control unit 50 applies braking force to the turning inner rear wheel so that braking slip rate of the turning inner rear wheel is coincident with the target braking slip rate Sbrint, whereby a turn assist yaw moment is imparted to the vehicle.

When the electronic control unit 50 is not executing the application of braking force by the turn assist control, it calculates an index Ddv of difficulty in driving vehicle by wheel drive forces. If the index Ddv is equal to or less than a reference value Ddvs (a positive constant), the electronic control unit 50 permits the application of braking force by the turn assist control. In contrast, if the index Ddv is larger than the reference value Ddvs, the electronic control unit 50 inhibits the application of braking force by the turn assist control.

When the electronic control unit 50 is executing the application of braking force by the turn assist control, it as well calculates an index Ddv of difficulty in driving vehicle by wheel drive forces. If the index Ddv is 0, the electronic control unit 50 does not decreasingly correct the target braking slip rate Sbrint. Whereas, if the index Ddv is positive, the electronic control unit 50 decreasingly corrects the target braking slip rate Sbrint, whereby the braking force applied to the turning inner rear wheel is reduced.

When the vehicle is under drive condition, the electronic control unit 50 calculates driving slip rates Sdrfl, Sdrfr, Sdrrl or Sdrrr of the wheels controlled by a traction control. When driving slip rate of any one of the wheels is excessively large, the electronic control unit 50 applies braking force to the wheel in accordance with driving slip rate, thereby conducting a traction control so as to reduce excessive driving slip. It is to be noted that in the turning inner rear wheel, the application of braking force by the turn assist control is executed in priority to the traction control.

Further, the electronic control unit 50 determines whether the vehicle is under an over-steer state or an under-steer state on a basis of state values of the vehicle detected by a yaw rate sensor and the like. That is, it determines whether or not application of braking force by vehicle dynamic control is required. When the electronic control unit 50 determines that braking force is to be applied, it executes over-steer state restraining control or an under-steer state restraining control in which braking force by vehicle dynamic control is applied to wheel or wheels to be controlled so as to stabilize turn motion of the vehicle.

In the over-steer state restraining control, in particular, the vehicle is imparted with yaw moment acting in turn restraining direction and is decelerated by means of braking force being applied to at least turning outer front wheel. On the other hand, in the under-steer state restraining control, braking forces are applied to at least left and right rear wheels and the braking force applied to turning inner rear wheel is set higher than the braking force applied to turning outer rear wheel so that the vehicle is decelerated and is imparted with yaw moment acting in turn promoting direction.

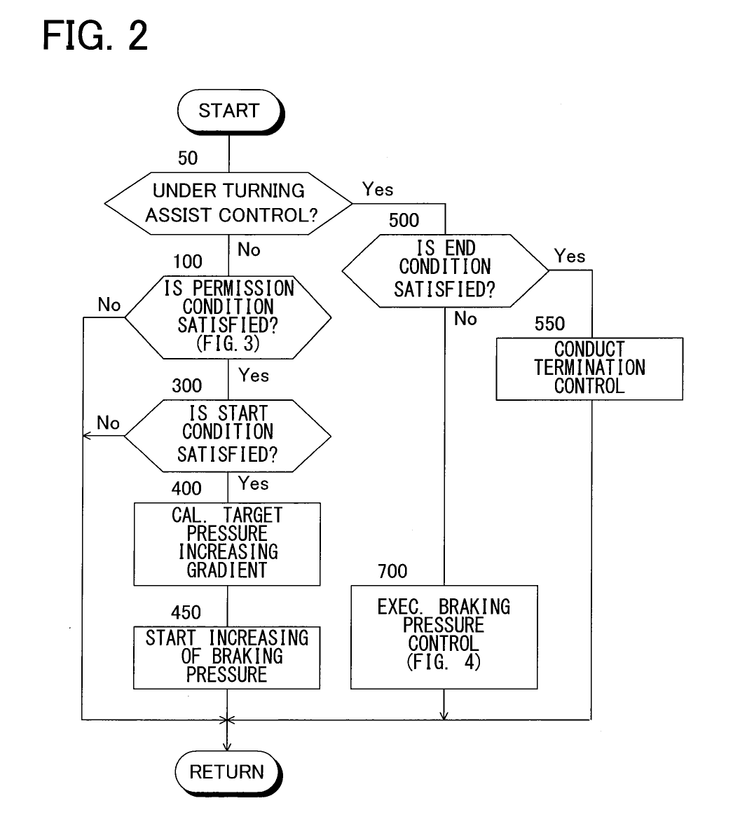

Next, the routine for conducting turn assist control in the first embodiment will be described with reference to the flowchart shown in FIG. 2. The control process according to the flowchart shown in FIG. 2 is initiated upon a closing (ON) of an ignition switch (not shown) and is performed repeatedly at predetermined time intervals.

After the control process begins, control proceeds to step 50, in which a decision is made as to whether or not the application of braking force by the turn assist control is being executed, that is, the application of braking force to the turning inner rear wheel is being executed. If an affirmative decision is made, the control proceeds to step 500, whereas if a negative decision is made, the control proceeds to step 100.

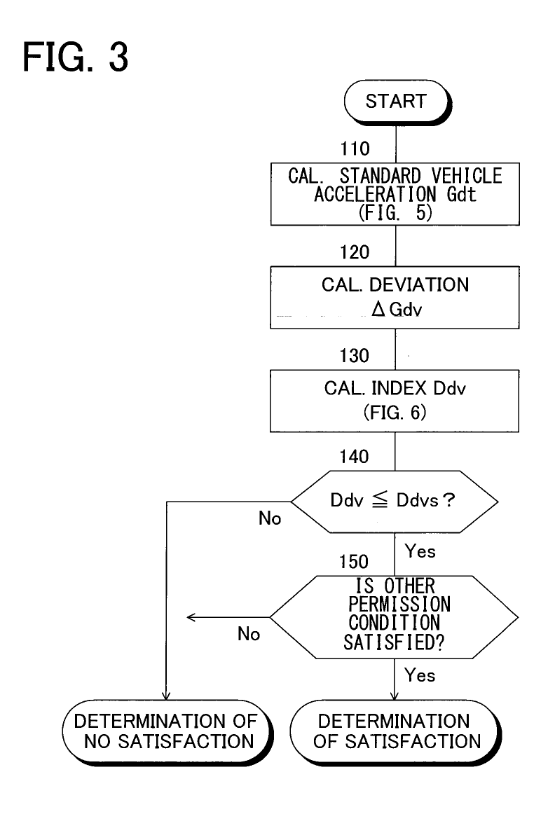

In step 100, a decision is made as to whether or not a permission condition for permitting the application of braking force by the turn assist control is satisfied according to the flowchart shown in FIG. 3. If a negative decision is made, the control ends, whereas if an affirmative decision is made, the control proceeds to step 300.

In step 300, a decision is made as to whether or not a start condition for starting the application of braking force by the turn assist control is satisfied. If a negative decision is made, the control ends, whereas if an affirmative decision is made, the control proceeds to step 400.

In this connection, a start condition may be considered to be satisfied when the following two conditions are satisfied: (a1) the absolute value of steering angle θ is equal to or larger than a reference value etas and (a2) the accelerator pedal 23 is depressed. It is to be noted that the reference value etas may be a positive constant or may be variably set in accordance with vehicle speed V so that when vehicle speed V is low, the reference value is larger as compared with the case where vehicle speed V is high.

In step 400, a target pressure increasing gradient ΔPbrint is calculated on the basis of the absolute value of steering angle θ so that when the absolute value of steering angle θ is large, the target pressure increasing gradient is larger as compared with the case where the absolute value of steering angle θ is small. It is to be noted that the target pressure increasing gradient ΔPbrint may be variably set in accordance with vehicle speed V so that when vehicle speed V is low, the target pressure increasing gradient is larger as compared with the case where vehicle speed V is high.

In step 450, the braking pressure of the turning inner rear wheel is controlled so that the pressure increasing gradient of the turning inner rear wheel is coincident with the target pressure increasing gradient ΔPbrint, whereby application of braking force to the turning inner rear wheel is started.

In step 500, a decision is made as to whether or not an end condition for ending the application of braking force by the turn assist control is satisfied. If a negative decision is made, the control proceeds to step 700, whereas if an affirmative decision is made, the control proceeds to step 550.

In this connection, an end condition may be considered to be satisfied when either of the following conditions is satisfied:

(b1) the absolute value of steering angle θ is equal to or smaller than a reference value θtae (a positive constant) for ending the control;
(b2) the turn assist switch 62 was changed over to OFF position;
(b3) application of braking force by vehicle dynamic control is to be executed;
(b4) application of braking force by the turn assist control can not normally be executed; and
(b5) the vehicle dynamic control can not normally be executed.

In step 550, braking pressure of the turning inner rear wheel is decreased, whereby application of braking force to the turning inner rear wheel is terminated.

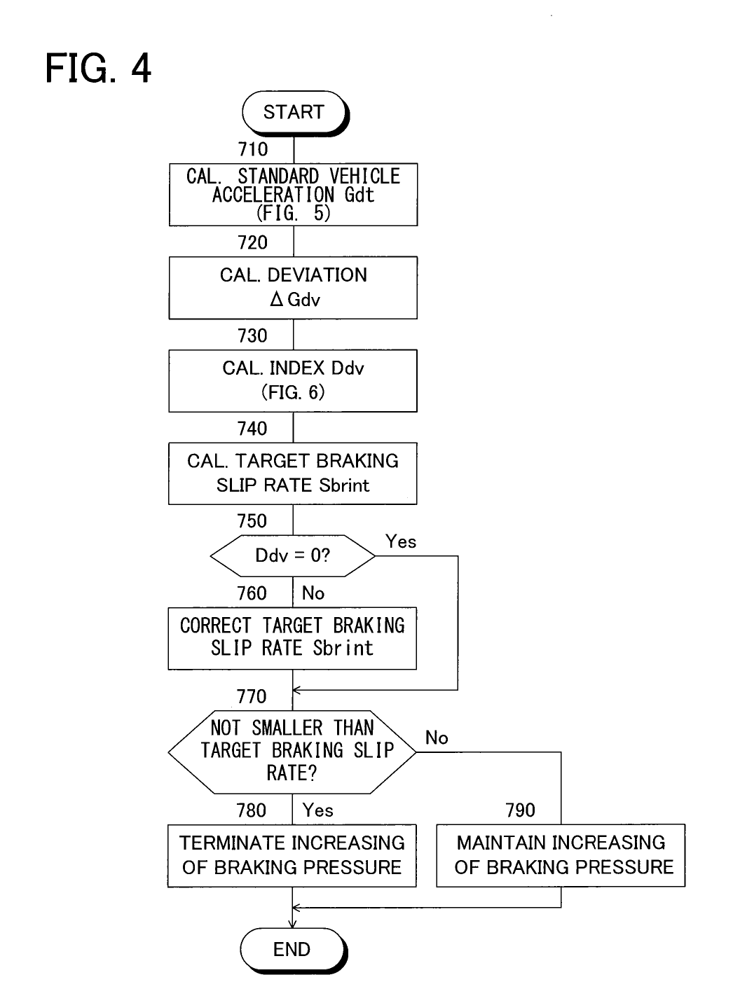

In step 700, braking pressure of the turning inner rear wheel is controlled according to the flowchart shown in FIG. 4. so that the application of braking force by the turn assist control is executed

Next, the sub-routine for determining the satisfaction of a permission condition for permitting the application of braking force by the turn assist control in step 100 will be described with reference to the flowchart shown in FIG. 3.

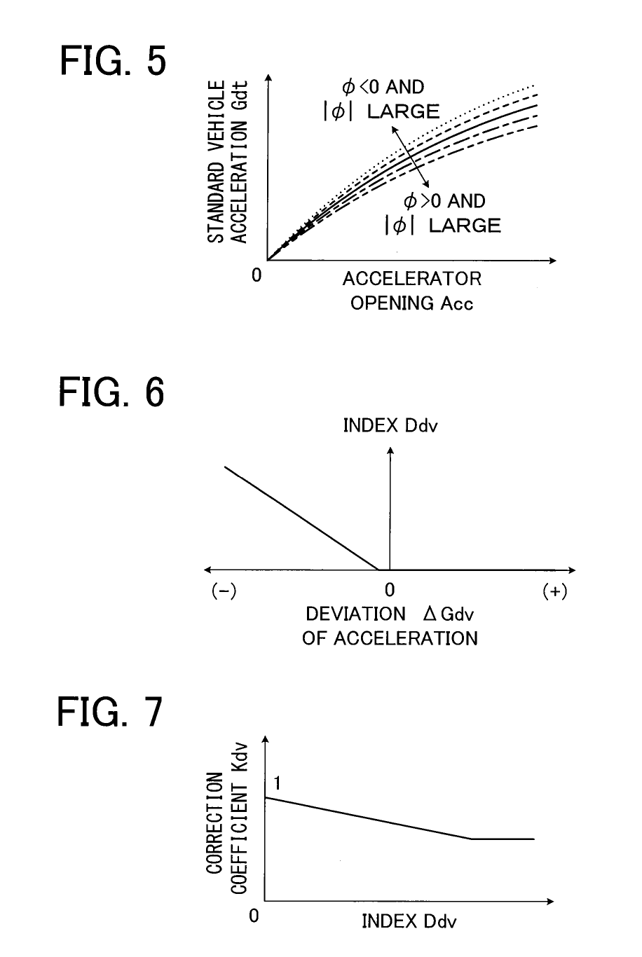

In step 110, standard vehicle acceleration Gdt is calculated based on accelerator opening Acc from a map shown in FIG. 5. As shown in FIG. 5, the standard vehicle acceleration Gdt is calculated so that it increases in accordance with an increase in accelerator opening Acc. In addition, the standard vehicle acceleration Gdt is calculated so that it decreases in accordance with an increase in vehicle inclination φ in magnitude while being positive and it increases in accordance with an increase in vehicle inclination φ in magnitude while being negative.

In step 120, a deviation (Gx-Gdt) between an actual acceleration Gx of the vehicle and a standard acceleration Gdt of the vehicle is calculated as an acceleration deviation ΔGdv.

In step 130, index Ddv of difficulty in driving vehicle by wheel drive forces is calculated based on the acceleration deviation ΔGdv from a map shown in FIG. 6. As shown in FIG. 6, the index Ddv of difficulty is calculated so that it increases in accordance with an increase in the acceleration deviation ΔGdv in magnitude while being negative and it is 0 when the acceleration deviation ΔGdv is equal to or larger than a negative reference value.

In step 140, a decision is made as to whether or not the index Ddv of difficulty in driving vehicle is equal to or smaller than the control start reference value Ddvs. If a negative decision is made, it is determined that the permission condition for permitting the application of braking force by the turn assist control is not satisfied, whereas if an affirmative decision is made, the control proceeds to step 150.

In step 150, a decision is made as to whether or not the other permission condition is satisfied. If a negative decision is made, it is determined that the permission condition for permitting the application of braking force by the turn assist control is not satisfied. On the other hand, if an affirmative decision is made, it is determined that the permission condition for permitting the application of braking force by the turn assist control is satisfied.

In this connection, the other permission condition may be considered to be satisfied when all of the following conditions are satisfied:

(c1) the sensors and the braking unit 42 are normal and the vehicle dynamic control can normally be executed;
(c2) the change-over switch 26 is set to L4 position;
(c3) the turn assist switch 62 is set to ON position; and
(c4) application of braking force by vehicle dynamic control is not being executed.

Next, the sub-routine for controlling the braking force of the turning inner rear wheel applied by the turn assist control in step 700 will be described with reference to the flowchart shown in FIG. 4.

Steps 710 to 730 are conducted in the same manner as in steps 110 to 130, respectively, whereby an index Ddv of difficulty in driving vehicle by wheel drive forces is calculated.

In step 740, a target braking slip rate Sbrint of the turning inner rear wheel is calculated based on the absolute value of steering angle θ so that it is larger when the absolute value of steering angle θ is large as compared with the case where the absolute value of steering angle θ is small. It is to be noted that the target braking slip rate Sbrint may be variably set as well in accordance with vehicle speed V so that when vehicle speed V is low, the target braking slip rate is larger as compared with the case where vehicle speed V is high.

In step 750, a decision is made as to whether or not the index Ddv of difficulty is 0, that is, no correction based on the index Ddv of difficulty is required to be conducted on the target braking slip rate Sbrint. If an affirmative decision is made, the control proceeds to step 770, whereas if a negative decision is made, the control proceeds to step 760.

In step 760, the target braking slip rate Sbrint is decreasingly corrected based on the index Ddv of difficulty so that the target braking slip rate Sbrint decreases in accordance with an increase in the index Ddv of difficulty which is positive. In this connection, as shown in FIG. 7, a positive correction coefficient Kdv which is not more than 1 may be calculated so that the correction coefficient decreases in accordance with an increase in the index Ddv of difficulty and the target braking slip rate Sbrint may be decreasingly corrected by multiplying it by the positive correction coefficient Kdv.

In step 770, a braking slip rate Sbrin of the turning inner rear wheel is calculated based on a reference wheel speed which is the lowest wheel speed among the wheel speeds of the three wheels other than the turning inner rear wheel. In addition, a decision is made as to whether or not the braking slip rate Sbrin of the turning inner rear wheel is equal to or higher than the target braking slip rate Sbrint. If an affirmative decision is made, the control proceeds to step 780, whereas if a negative decision is made, the control proceeds to step 790.

In step 780, increasing of braking pressure of the turning inner rear wheel is terminated, whereby increasing of braking force of the turning inner rear wheel is terminated. On the other hand, in step 790, increasing of braking pressure of the turning inner rear wheel is maintained, whereby increasing of braking force of the turning inner rear wheel is maintained.

According to the first embodiment, when the turn assist control is to be started, negative, affirmative, and affirmative decisions are made in steps 50, 100 and 300, respectively. In steps 400 and 450, application of braking force to the turning inner rear wheel is started and the braking slip rate Sbrin of the turning inner rear wheel is controlled so that it is coincident with the target braking slip rate Sbrint until an affirmative decision is made in step 500.

Thus, a yaw moment by the difference of braking forces of left and right wheels is imparted to the vehicle in turn assist direction, whereby vehicle turn is assisted. Accordingly, turning performance of the vehicle is enhanced as compared with the case where application of braking force by the turn assist control is not executed.

According to the first embodiment, under the situation where application of braking force by the turn assist control is executed, an index Ddv of difficulty in driving vehicle by wheel drive forces is calculated in steps 710 to 730. When an index Ddv of difficulty is positive, the target braking slip rate Sbrint is decreasingly corrected so that it decreases in accordance with an increase in the index Ddv of difficulty.

Thus, according to the first embodiment, when an index Ddv of difficulty increases while it is positive as in the case where the vehicle enters into a sandy land area under the situation where application of braking force by the turn assist control is executed, the target braking slip rate Sbrint is decreasingly corrected in accordance with the index. Therefore, a possibility can be reduced that the driving force of the entire vehicle is in short for the reason that application of high braking force to the turning inner rear wheel is continued and that due to this, the driver feels difficulty in running the vehicle.

According to the first embodiment, in particular, the target braking slip rate Sbrint is decreasingly corrected so that it decreases in accordance with an increase in the index Ddv of difficulty. Thus, even if the index Ddv of difficulty varies in magnitude, the target braking slip rate Sbrint does not change drastically. Accordingly, the vehicle running control apparatus can prevent rapid changes in the braking force of the turning inner rear wheel and in the driving force of the entire vehicle which are caused by drastic change in the target braking slip rate Sbrint.

When the driving force of the entire vehicle is recovered, the driving operation amount of the driver is in general decreased. Thus, the acceleration deviation ΔGdv decreases in magnitude, whereby the index Ddv of difficulty lowers in magnitude. Accordingly, decreasing correction amount of the target braking slip rate Sbrint can be reduced in accordance with the recovery degree of the driving force of the entire vehicle.

According to the first embodiment, under the situation where application of braking force by the turn assist control is not executed, an index Ddv of difficulty in driving vehicle by wheel drive forces is calculated in steps 110 to 130. When an index Ddv of difficulty is positive, irrespective of whether or not the other permission condition is satisfied, it is determined that a permission condition for permitting application of braking force by the turn assist control is not satisfied, whereby the application of braking force by the turn assist control is inhibited.

Thus, according to the first embodiment, even when steering angle is increased in magnitude while the vehicle runs at sandy place or the like and the application of braking force by the turn assist control is to be executed, the application of braking force is not started so long as the index Ddv of difficulty is positive and large. Therefore, a possibility can be reduced that the driving force of the entire vehicle is in short for the reason that the application of high braking force to the turning inner rear wheel is started and that due to this, the driver feels difficulty in running the vehicle.

According to the first embodiment, standard vehicle acceleration Gdt for calculating the index Ddv of difficulty is not only calculated so that it increases in accordance with an increase in accelerator opening Acc, but it is also calculated accounting for vehicle inclination φ. Therefore, standard vehicle acceleration Gdt can appropriately be calculated in accordance with vehicle inclination φ, whereby the index Ddv of difficulty can appropriately be calculated irrespective of the sign and magnitude of vehicle inclination φ.

### Second Embodiment

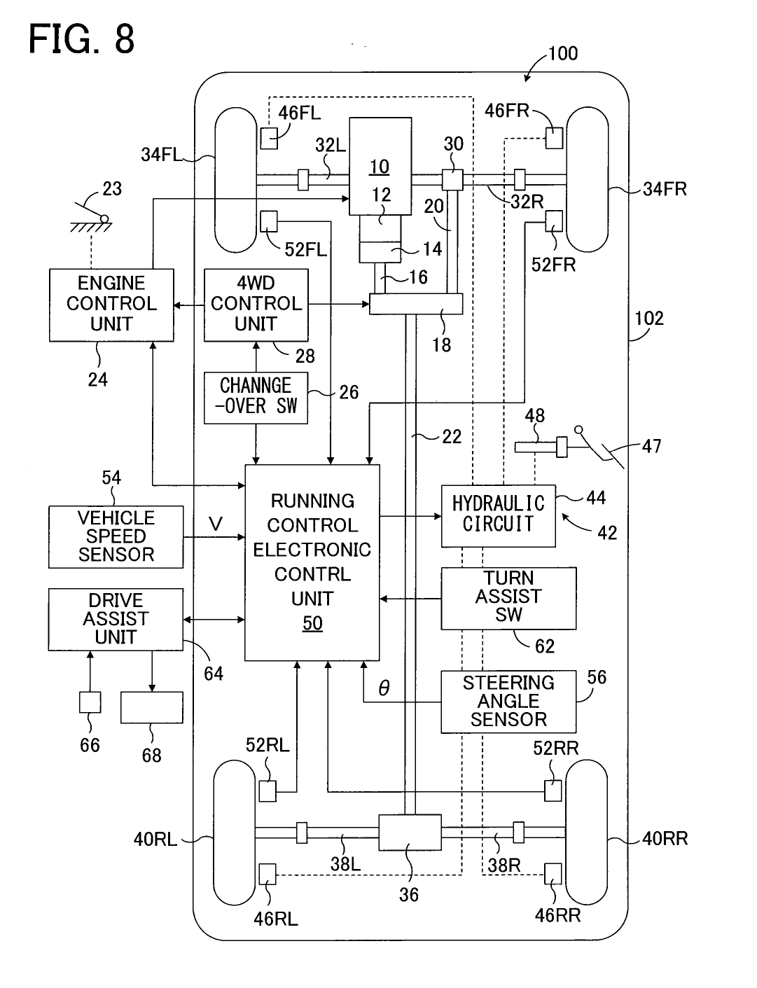

FIG. 8 is a schematic diagram of a second embodiment of a vehicle running control apparatus according to the invention which is applied to a four-wheel drive vehicle.

In FIG. 8, members similar to those appearing in FIG. 1 are denoted by the same reference numerals as those appearing in FIG. 1.

In the present second embodiment, as shown in FIG. 8, the vehicle 102 is provided with a drive assist unit 64. When a mode is selected by means of selection switch 66 based on driver's determination on road surface condition, the drive assist unit 64 displays on a monitor 68 drive assist information which advises the driver with respect to driving operations. The drive assist unit 64 conducts traction control optimally in accordance with the selected mode.

Specifically, the selection switch 66 is adapted to allow the selection of four modes: “MUD & SAND”, “LOOSE ROCK”, “MOGUL” and “ROCK.” “MUD & SAND” is to be selected under the situation where road surface is slippery as in the cases of slip land, sandy place, or deep snow. “LOOSE ROCK” is to be selected under the situation where road surface is slippery as in the cases where road surface is formed by mixture of soil and small stones such as rubble road or bush. “MOGUL” is to be selected under the situation where road surface is highly irregular as in the cases of steps, graves, inclined land, or slope. “ROCK” is to be selected under the situation where road surface is rocky as in the cases of rocky stretch.

It is to be noted that this type of drive assist unit is equipped in some of commercial off-road vehicles under the trade name “TELE IN SELECT”, for example.

Again in the second embodiment, when the change-over switch 26 is ON, the electronic control unit 50 determines whether or not the application of braking force by the turn assist control is to be executed. If the electronic control unit 50 determines that the application of braking force is to be executed, it calculates a target braking slip rate Sbrint of a turning inner rear wheel. Then, the electronic control unit 50 applies braking force to the turning inner rear wheel so that a braking slip rate of the turning inner rear wheel is coincident with the target braking slip rate Sbrint, whereby a turn assist yaw moment is imparted to the vehicle.

Under the situation where application of braking force by the turn assist control is not executed, the electronic control unit 50 decides whether or not the mode selected by the selection switch 66 in the drive assist unit 64 is “MUD & SAND.” The electronic control unit 50 allows the application of braking force by the turn assist control when the selected mode is other than “MUD & SAND”, but it inhibits the application of braking force by the turn assist control when the selected mode is “MUD & SAND.”

Under the situation where application of braking force by the turn assist control is executed, the electronic control unit 50 as well decides whether or not the mode selected by the selection switch 66 in the drive assist unit 64 is “MUD & SAND.” When the selected mode is “MUD & SAND”, the electronic control unit 50 terminates the application of braking force by the turn assist control. In contrast, when the selected mode is other than “MUD & SAND”, the electronic control unit 50 decreasingly corrects the target braking slip rate Sbrint in accordance with the selected mode, whereby the braking force applied to the turning inner rear wheel is reduced.

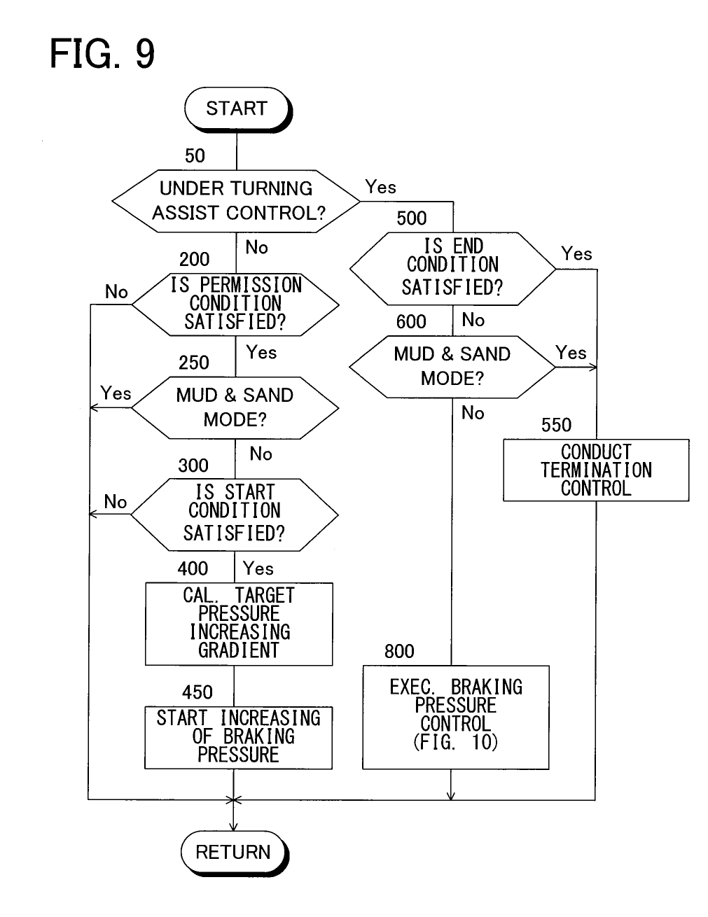

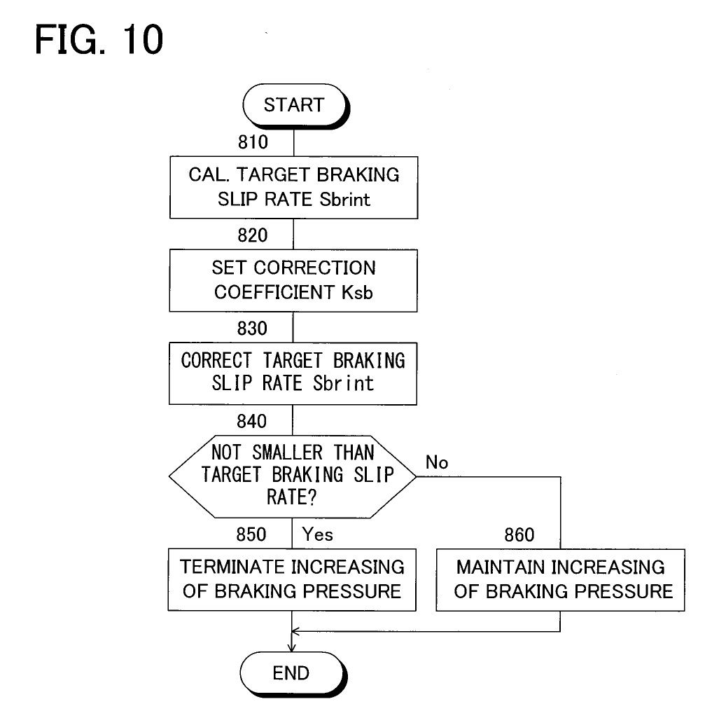

FIG. 9 is a flowchart showing a routine for conducting turn assist control in the second embodiment and FIG. 10 is a flowchart showing a sub-routine for conducting braking pressure control for the turn assist control in the second embodiment.

In FIGS. 9 and 10, the steps corresponding to those shown in FIGS. 2 and 4 are denoted by the same step numbers as in FIGS. 2 and 4.

As shown in FIGS. 9, in the second embodiment, if a negative decision is made in step 50, the control proceeds to step 200. In step 200, a decision is made as to whether or not a permission condition for permitting the application of braking force by the turn assist control is satisfied by determining whether or not all the above-described conditions c1 to c4 are satisfied. If a negative decision is made, the control once ends, whereas if an affirmative decision is made, the control proceeds to step 250.

In step 250, a decision is made as to whether or not the mode selected by the selection switch 66 is “MUD & SAND.” If an affirmative decision is made, the control once ends, whereas if a negative decision is made, the control proceeds to step 300.

If a negative decision is made in step 500, the control proceeds to step 600. In step 600, as in step 250, a decision is made as to whether or not the mode selected by the selection switch 66 is “MUD & SAND.” If an affirmative decision is made, the control proceeds to step 550, whereas if a negative decision is made, the control proceeds to step 800.

In step 800, the braking pressure of the turning inner rear wheel is controlled according to the flowchart shown in FIG. 10, whereby the application of braking force by the turn assist control to the turning inner rear wheel is executed.

In step 810 in the sub-routine for conducting braking pressure control of the turning inner rear wheel shown in FIG. 10, a target braking slip rate Sbrint of the turning inner rear wheel is calculated as in step 740 in the first embodiment. That is, a target braking slip rate Sbrint of the turning inner rear wheel is calculated on the basis of the absolute value of steering angle θ so that it is larger when the absolute value of steering angle θ is large as compared with the case where the absolute value of steering angle θ is small. It is to be noted that again in the present embodiment, the target braking slip rate Sbrint may variably be set in accordance with vehicle speed V so that when vehicle speed V is low, the target braking slip rate is larger as compared with the case where vehicle speed V is high.

In step 820, a correction coefficient Ksb is set to a positive value which is smaller than 1 in accordance with the mode selected by the selection switch 66. For example, when the selected mode is either of “LOOSE ROCK”, “MOGUL” and “ROCK”, the correction coefficient Ksb is set to 0.3, 0.5 and 0.7, respectively.

In step 830, the target braking slip rate Sbrint is decreasingly corrected by multiplying it by the correction coefficient Ksb, and then steps 840 to 860 are conducted as in the steps 770 to 790 in the first embodiment.

Thus, according to the second embodiment, when the turn assist control is to be started, negative, affirmative, negative, and affirmative decisions are made in steps 50, 200, 250 and 300, respectively. In steps 400 and 450, application of braking force to the turning inner rear wheel is started and the braking slip rate Sbrin of the turning inner rear wheel is controlled so that it is coincident with the target braking slip rate Sbrint until an affirmative decision is made in step 500 or 600.

Thus, as in the first embodiment, a yaw moment by the difference between braking forces of left and right wheels is imparted to the vehicle in turn assist direction, whereby vehicle turn is assisted. Accordingly, turning performance of the vehicle is enhanced as compared with the case where the application of braking force by the turn assist control is not executed.

According to the second embodiment, even though a negative decision has been made in step 500, when an affirmative decision is made in step 600, in step 550, the braking pressure of the turning inner rear wheel is reduced, whereby the application of braking force to the turning inner rear wheel is terminated.

Therefore, according to the second embodiment, if the mode “LOOSE ROCK” is selected, as in the case where the vehicle enters into sandy place area under the situation where the application of braking force by the turn assist control is executed, the application of braking force to the turning inner rear wheel can be terminated. Therefore, a possibility can be reduced that the driving force of the entire vehicle is in short for the reason that the application of braking force to the turning inner rear wheel is continued under the situation where difficulty in driving vehicle by wheel drive forces is very high, and that due to this, the driver feels difficulty in running the vehicle.

According to the second embodiment, under the situation where application of braking force by the turn assist control is executed, in steps 820 and 830, the correction coefficient Ksb is set to a positive value which is smaller than 1 in accordance with the mode selected by the selection switch 66. In other words, the correction coefficient Ksb is set in accordance with the difficulty in driving vehicle by wheel drive forces. Thus, the target braking slip rate Sbrint is decreasingly corrected so that it decreases as the difficulty increases.

Therefore, according to the second embodiment, as in the case where vehicle enters into rubble road area or the like under the situation where application of braking force by the turn assist control is executed, the target braking slip rate Sbrint can be decreasingly corrected in accordance with the difficulty in driving vehicle by wheel drive forces. Therefore, a possibility can be reduced that the driving force of the entire vehicle is in short for the reason that the application of high braking force to the turning inner rear wheel is continued in spite of the increase of the difficulty in driving vehicle and that due to this, the driver feels difficulty in running the vehicle.

According to the second embodiment, under the situation where the application of braking force by the turn assist control is not executed, even if an affirmative decision is made in step 200, the application of braking force by the turn assist control is inhibited so long as the mode “LOOSE ROCK” is selected.

Thus, according to the second embodiment, even when steering angle is increased in magnitude under the situation where the vehicle runs at sandy place or the like, resulting in the application of braking force by the turn assist control being required, the application of braking force by the turn assist control is not started so long as the mode “LOOSE ROCK” is selected. Therefore, a possibility can be reduced that the driving force of the entire vehicle is in short for the reason that the application of high braking force to the turning inner rear wheel is started and that due to this, the driver feels difficulty in running the vehicle.

While the present invention has been described with reference to the above embodiments, it will be apparent to those skilled in the art that the present invention is not limited thereto, but may be embodied in various other forms without departing from the scope of the invention.

For example, in the above-described embodiments, the turn assist control applies braking force so that braking slip rate of the turning inner rear wheel is coincident with a target braking slip rate. However, braking force may be applied so that braking slip amount or braking pressure of the turning inner rear wheel is coincident with a target value so as to control braking force of the turning inner rear wheel to a target braking force.

In the above-described embodiments, a target pressure increasing gradient ΔPbrint of the turning inner rear wheel is calculated based on the absolute value of steering angle θ, whereby the target pressure increasing gradient is variably set according to the absolute value of steering angle e. However, the target pressure increasing gradient may be a constant.

In the above-described first embodiment, standard vehicle acceleration Gdt is calculated on the basis of accelerator opening Acc; a deviation between an actual acceleration Gx of the vehicle and a standard acceleration Gdt of the vehicle is calculated as an acceleration deviation ΔGdv; and an index Ddv of difficulty in driving vehicle by wheel drive forces is calculated on the basis of the acceleration deviation LGdv. However, the index Ddv of difficulty may be calculated in any other manner so long as it includes at least one of resistance against vehicle movement by wheel drive forces and difficulty in transmitting driving force from wheels to road surface such that it indicates difficulty in driving vehicle by wheel drive forces. For example, the index may be calculated on the basis of a deviation between an actual changing rate of vehicle speed and a standard changing rate of vehicle speed based on accelerator opening Acc.

In the above-described first embodiment, vehicle inclination cp is accounted for in calculating a standard acceleration Gdt of the vehicle. However, a standard acceleration Gdt of the vehicle may be calculated without accounting for vehicle inclination cp. Live load of the vehicle may be accounted for in calculating a standard acceleration Gdt of the vehicle so that a standard acceleration Gdt decreases as live load of the vehicle increases.

In the above-described first embodiment, in addition to a normal permission condition for permitting application of braking force by the turn assist control (step 150), the magnitude of the index Ddv of difficulty is decided in steps 110 to 140 as additional permission condition. However, the latter steps may be omitted.

Likewise, in the above-described first embodiment, in addition to a normal permission condition for permitting application of braking force by the turn assist control (step 200), step 250 is conducted for deciding additional permission condition. However, the step 250 may be omitted.

In the above-described embodiments, reduction in wheel longitudinal force is performed by means of applying braking force to the wheel. However, if the wheel is a driving wheel, reduction in wheel longitudinal force may be performed by means of reducing driving force or reducing driving force and applying braking force to the wheel

In the above-described embodiments, the turn assist control applies braking force to the turning inner rear wheel. However, braking force may be applied to a turning inner front wheel. Alternatively, braking force may be applied to a turning inner wheel and driving force may be applied to a turning outer wheel.

In the above-described embodiments, the vehicle is a four-wheel drive vehicle. However, the vehicle running control apparatus may be applied to a rear drive vehicle or a front drive vehicle.

In the above-described embodiments, the over-steer state restraining control and the under-steer state restraining control are executed as vehicle dynamic control. However, these controls may be omitted.

1. A vehicle running control apparatus for executing a turn assist control which controls longitudinal forces of wheels so that longitudinal force of a turning inner wheel is lower than longitudinal force of a turning outer wheel by lowering the longitudinal force of the turning inner wheel, wherein the vehicle running control apparatus sets smaller a lowering amount of the longitudinal force of the turning inner wheel when difficulty in driving vehicle by wheel drive forces is high as compared with the case where the difficulty in driving vehicle is low.

2. A vehicle running control apparatus according to claim 1, wherein the vehicle running control apparatus makes the lowering of the longitudinal force of the turning inner wheel more difficult to be started when the difficulty in driving vehicle is high as compared with the case where the difficulty in driving vehicle is low.

3. A vehicle running control apparatus according to claim 1, wherein the vehicle running control apparatus calculates an index of difficulty in driving vehicle by wheel drive forces and, when the index is equal to or larger than a correction decision reference value under the situation where the lowering of the longitudinal force of turning inner wheel is conducted, decreases the lowering amount of the longitudinal force of the turning inner wheel so that the lowering amount decreases as the index increases.

4. A vehicle running control apparatus according to claim 3, wherein the vehicle running control apparatus terminates the lowering of the longitudinal force of the turning inner wheel when the index is equal to or larger than a termination decision reference value which is larger than the correction decision reference value.

5. A vehicle running control apparatus according to claim 2, wherein the vehicle running control apparatus calculates an index of difficulty in driving vehicle by wheel drive forces and, when the index is equal to or larger than a start correction reference value at a time when the lowering of the longitudinal force of the turning inner wheel is started, increases a reference value for starting the lowering of the longitudinal force of the turning inner wheel.

6. A vehicle running control apparatus according to claim 5, wherein the vehicle running control apparatus inhibits starting of the lowering of the longitudinal force of the turning inner wheel when the index is equal to or larger than a start decision reference value which is larger than the start correction reference value.

7. A vehicle running control apparatus according to any one of claims 1 to 6, wherein the vehicle has a selection switch which is operated by a vehicle occupant based on his or her determination on road surface condition and a drive assist unit which displays optimum driving operations in accordance with the operational position of the selection switch, and the vehicle running control apparatus decides the difficulty in driving vehicle on the basis of the operational position of the selection switch.

8. A vehicle running control apparatus according to any one of claims 1 to 6, wherein the difficulty in driving vehicle includes at least one of resistance against vehicle movement by wheel drive forces and difficulty in transmitting driving forces from wheels to road surface.
